(19) United States
(12) Patent Application Publication
(10) Pub. No.: US 2006/0254908 A1
(43) Pub. Date: Nov. 16, 2006

(54) Electrochemical solid electrolyte sensor for the detection of oxygen, hydrocarbons and moisture in vacuum environments

(76) Inventors: Robert Bruce Grant, Steyning West Sussex (GB); Patrick Davis, Dundrum Newcastle Co Down (GB); Carolyn Hughes, Forest Row (GB)

Correspondence Address: THE BOC GROUP, INC., 575 MOUNTAIN AVENUE, MURRAY HILL, NJ, 07974-2064, US

(21) Appl. No.: 10/551,147

(22) PCT Filed: Mar. 5, 2004
(86) PCT No.: PCT/GB04/00934

§ 371 Date: Sep. 22, 2005

(30) Foreign Application Priority Data
Apr. 17, 2003 (GB) 0308939.8

(51) Int. Cl. G01N 27/26

(52) U.S. Cl. 204/400

(57) ABSTRACT

A contaminant molecule sensor for the detection of oxygen, hydrocarbons and humidity comprises an electrochemical cell for use in vacuum, The cell comprises a measurement electrode (2), a reference electrode (3) and a solid-state ionic species conductor (1) bridging the measurement electrode and the reference electrode. The measurement electrode comprises a catalyst selected for its ability to catalyse the dissociation of a contaminant’ molecule into its ionic species. The reference electrode comprises a catalyst selected for its ability to catalyse the dissociation of a reference molecule into its ionic species. The conductor is selected to conduct an ionic species common to the dissociated contaminant and reference molecules.

The present invention relates to sensors for the detection of contaminants such as oxygen, hydrocarbons and moisture in a controlled atmosphere environment and in particular to sensors with high sensitivity below normal atmospheric pressure.

In, for example, the semiconductor manufacturing industry, it is important to control the atmosphere in which wafers are manufactured. The wafers are desirably manufactured in a controlled environment. Undesirable or varying levels of contaminant, such as oxygen, hydrocarbons or water vapour can result in wafers having variable and often poor quality. Various practices are adopted to reduce the levels of contaminant in the manufacturing environment including the use of in-line filters and purging of the environment. Nevertheless, undesirable levels of some contaminants occasionally find their way into gas lines or other equipment used in the manufacturing process. Thus it is desirable to be able to monitor the processing environment for the presence of contaminants.

Monitoring contaminant species in ambient environments (i.e. under atmospheric conditions) is a well established field of measurement science with a plethora of sensing technologies utilised to monitor and measure a variety of target gases. For example, electrochemical cells (incorporating a liquid electrolyte) are routinely used within industry to monitor ambient oxygen (O₂) levels. Hydrocarbons can be routinely monitored using common tin oxide (SnO₂) based sensor devices, and water vapour is effectively measured using solid-state aluminium oxide (Al₂O₃) based sensing devices. These sensors typically operate under atmospheric pressure to detect target gases in the range from a few ppm (parts per million) to several thousand ppm. This represents an approximate three-decade detection range across which these sensors can operate. This type of sensor works effectively within these ranges by providing a linear output signal that is directly proportional to the quantity of target gas within the monitored environment.

Throughout the vacuum manufacturing industry there is an increasing demand for greater monitoring and control of contaminants within the processing environment. For example, in the semiconductor manufacturing industry the continuing trend towards smaller semiconductor device structures is placing an increasing importance upon the control, monitoring and elimination of contaminant species within the processing environment to ppb (parts per billion) levels and lower. Semiconductor wafers are manufactured in strictly controlled reduced pressure environments (i.e. vacuum) where the presence of any undesirable contaminants such as oxygen, hydrocarbons or water vapour can result in wafers with poor quality or variable characteristics. Whilst a number of practices are adopted to reduce contaminant levels in the manufacturing environment (such as the use of in-line filters and purged environments) the possibility of undesirable levels of some contaminants occasionally finding their way into the manufacturing process still exists. Hence, it is desirable to continuously monitor the vacuum-processing environment for the presence of potential contaminant species.

Whilst conventional gas sensor technology, as outlined above, is suitable for monitoring contaminant species within ambient environments they do not lend themselves for applications within sub-atmospheric processing environments. As noted, conventional sensors typically exhibit a linear output signal that is directly proportional to the levels of the target contaminant being monitored. Sensors that display linear output signals are suitable for operation under ambient conditions and to monitor the four-decade detection range typically required for such environments (i.e. from a few ppm to several thousand ppm). However, they do not lend themselves to applications within the semiconductor processing where typical process conditions can span a thirteen-decade pressure range, from 1 e⁻¹⁰ mbar to approx. 1000 mbar. Within this pressure range a sensor can be required to detect contaminant levels ranging from ppt (parts per trillion) to several tens of thousands of ppm (i.e. an eight-decade detection range or greater).

In addition, vacuum environments by their nature are reducing environments and many conventional ambient sensors will provide incorrect measurements if used under these conditions. The physical design of conventional sensors is such that their construction and sensitivity is not optimised to measure the low number of molecules of a target species within a vacuum. For example, there are approximately 1 billion less gas molecules per cm³ in a 1 e⁻⁶ mbar vacuum environment than at atmospheric pressure. Hence, sensors for use in vacuum environments must be designed specifically to account for the reduced quantity and different flow characteristics of gaseous species within a vacuum environment.

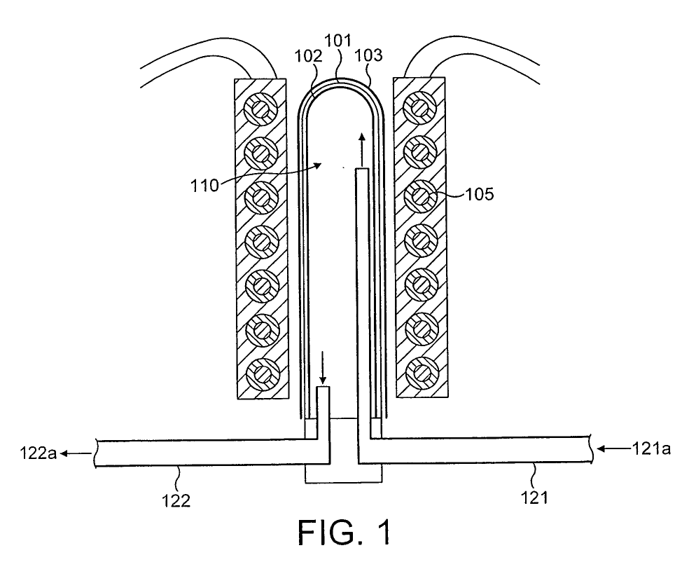

Considering the above issues it is noted that conventional electrochemical cell technology (typically used for monitoring oxygen levels in ambient) will not work in a vacuum environment. If exposed to a vacuum environment the liquid electrolyte within the electrochemical cell will rapidly evaporate resulting in signal drift and failure within a short period of time. Sensors that incorporate solid-state electrolytes, such as zirconia, may provide an alternative option. Solid-state zirconia based electrochemical sensors are widely used throughout modern industry to monitor oxygen levels under ambient conditions. FIG. 1 shows a typical example of a zirconia based oxygen sensor used in industry. A thimble of zirconia is coated on its interior and exterior surfaces with a catalytic conducting electrode and the entire component is heated externally. The gaseous sample to be monitored is passed through an arrangement of pipe-work to the internal measurement electrode of the sensor whilst the outer reference electrode is exposed to the ambient reference. The physical construction of this sensor is such that it works well for ambient monitoring conditions. However, if used for vacuum applications the sensor will suffer from outgassing effects (from the measurement electrode) during evacuation and conductance issues will give incorrect measurements and poor response times. Under vacuum conditions the SnO₂ type of sensor (typically used for monitoring hydrocarbon levels in ambient) will suffer from reduction of the active oxide content leading to signal drift and non-response after a period of time. In principle it is possible to use the Al₂O₃ type of sensors (typically used for monitoring water vapour levels in ambient) within a vacuum environment. However, due to diffusion effects within the rarefied vacuum environment these sensors will have a very slow speed of response and would not provide a sufficiently quick indication of contaminant ingress into the processing environment to render them useful for vacuum applications.

In general, to perform useful measurements within a vacuum environment it is necessary to utilise equipment that is specifically designed for use at low pressure in preference to equipment designed for ambient operation. For example, to measure ambient pressure levels ranging from 1 e⁻³ mbar to approx. 1000 mbar conventional pressure gauges (e.g. diaphragm type gauges) are typically used. These sensors are usually selected to cover a three-decade pressure range and provide a linear output signal across the required pressure range. However, in order to measure pressure in vacuum environments under 1 e⁻³ mbar pressure it is necessary to utilise a different type of sensor, e.g. ion gauges. Ion gauges are hot filament sensors and measure the pressure by ionising gaseous molecules and measuring the ionic signal in order to provide an accurate pressure indication. Ion gauges provide a log-linear output signal allowing them to operate over several decades (i.e. from 10⁻¹⁰ mbar to 10⁻³ mbar) with the required sensitivity to operate in vacuum environments. Similarly, in order to measure the quantity of any residual gaseous species present within a vacuum environment it is necessary to employ specially designed equipment for vacuum use such as Residual Gas Analysers (RGA). These instruments work by ionising gaseous species within the vacuum and identify the individual gaseous species by using a mass selective detector that can differentiate the ions from different gaseous species in order to assist with the identification and quantification of each. Whilst RGA instruments typically operate in pressure ranges below 1 e⁻⁴ mbar they can be modified to operate at pressures above 1 e⁻⁴ mbar by employing an expensive differentially pumped arrangement. Differential pumping requires the use of an independent vacuum system (usually requiring two additional vacuum pumps) to evacuate an analysis chamber that is connected to the environment to be monitored via a small leak or a fine leak valve arrangement. Although this provides a solution to measuring gaseous species across the wide pressure ranges experienced within the semiconductor processing environment the cost of installing RGA equipment throughout a typical semiconductor manufacturing facility makes such an approach prohibitive.

There is a requirement within the semiconductor manufacturing industry to provide cost-effective technology to continuously monitor the atmosphere within the processing environment for potential contaminants. However, due to the wide pressure ranges used during processing (i.e. from 1 e⁻¹⁰ mbar to atmospheric pressure levels) there is presently no single solution to meet this requirement.

The present invention aims to provide a chemical species sensor which can accurately monitor the presence and quantity of selected species in a wide range of environments including extremes of ambient pressure as well as at normal atmospheric pressure. The sensor is intended to be of particular use in low pressure environments such as vacuum or the inert purged environments now commonly used in the semiconductor manufacturing industry.

A first aspect of the present invention provides a contaminant molecule sensor configured for use in a vacuum environment, the sensor comprising an electrochemical cell comprising a measurement electrode comprising a catalyst selected for its ability to catalyse the dissociation of the contaminant molecule into its ionic species, a reference electrode comprising a catalyst selected for its ability to catalyse the dissociation of a reference molecule into its ionic species, a solid-state ionic species conductor bridging the measurement electrode and the reference electrode, the conductor being selected to conduct an ionic species common to the disassociated contaminant and reference molecules, and means for initiating catalysis of the dissociation of the contaminant and reference molecules.

In use the cell is used in conjunction with a device for measuring the electrical characteristics of the cell. For example, but without limitation, the device may be configured to measure the electrical current (in an amperometric configuration) or the emf (in a potentiometric configuration) produced across the cell.

Each electrode may be comprised from, or coated with, its respective catalyst. The “catalyst” electrode materials may be a metal, a conducting oxide or another suitable catalysing material. The selection of the electrode material will favour the dissociation of the species of interest whilst minimising the dissociation for permanent (ie not of interest) species. The skilled addressee will no doubt envisage appropriate catalysts for separating certain ionic species from certain molecules without departing from the invention. Without limitation, catalysts may include platinum (for liberating H⁺ from water or O²⁻ from molecular oxygen), ruthenium (for liberating H⁺ from hydrocarbons), nickel, gold, silver or silver salts.

During use of the sensor, a reference environment with known quantities of the species is provided within the reference environment space. This is used as a reference with which the measured quantity of the species in the monitored environment contained in the monitored environment space can be compared. By applying a suitable algorithm incorporating measured parameters of the electrical signal generated by the cell and known characteristics of the reference environment, the partial pressure, and thus relative quantity of the species in the monitored environment can be calculated.

In circumstances where it would be relatively straightforward to provide a reference environment which contains, as the reference molecule, a known quantity of the same chemical species as the contaminant molecule, for example, O₂, the catalyst for the measurement electrode may conveniently comprise the same material as the catalyst for the reference electrode. However, where it would be relatively difficult to provide such a reference environment, for example, where the contaminant molecule is H₂O, depending on the chosen reference molecule the catalyst for the measurement electrode may comprise different material from the catalyst for the reference electrode. Even in this latter situation, the catalysts may still comprise the same material, for example platinum would be a suitable catalyst for the dissociation of H₂O as a contaminant molecule and for the dissociation of H₂ as a reference molecule.

The reference environment space may be a sealed enclosure into which a controlled environment is provided. The source of ionic species provided in the reference environment may be a source of the contaminant molecule or any other source of that ionic species. The source may be provided in any physical phase, for example, but not limited to a gas, a liquid or a solid. For ease of storage and handling, a solid-state source is preferable. Suitable solid-state sources will no doubt occur to the skilled addressee. Examples of suitable reference environment sources include but are not strictly limited to a gas, a metal, a metal/metal-hydride, a metal alloy/metal-hydride, any solid hydrated species, any solid organic species (for H⁺) or copper/copper oxide (Cu₂O), nickel/nickel oxide (NiO) and chromium/chromium oxide (Cr₂O₃) (for O₂₋).

Other suitable sources may include but are not limited to organic acids or liquid organic species (for H⁺).

The means for initiating the catalysis of the dissociation of the molecules preferably comprises means for controlling and monitoring the temperature of the cell. In the preferred embodiments, sealing means are provided for separating a reference environment space from a monitored environment space, the means for controlling the temperature of the cell including a heating device contained within the reference environment space. Thus, in a second aspect the present invention provides a contaminant molecule sensor configured for use in a vacuum environment, the sensor comprising an electrochemical cell comprising a measurement electrode coated with, or comprised from, a catalyst selected for its ability to catalyse the dissociation of a contaminant molecule into its ionic species, a reference electrode coated with, or comprised from, a catalyst selected for its ability to catalyse the dissociation of a reference molecule into its ionic species, and a solid-state ionic species conductor bridging the measurement electrode and the reference electrode, the conductor being selected to conduct an ionic species common to the dissociated contaminant and reference molecules, means for controlling and monitoring the temperature of the cell, and sealing means for separating a reference environment space from a monitored environment space, the means for controlling and monitoring the temperature of the cell including a heating device contained within the reference environment space

The means for controlling and monitoring the temperature may include an electrically powered heater, for example a nichrome wire wound heater. It will be appreciated that a heat conductive material may be heated by means other than electrical. The means may further comprise a temperature sensor, for example, but not strictly limited to a thermocouple. The range of temperature controllable and monitored by the means may extend from low to very high temperatures so as to permit selection of a temperature to optimise catalysis of the dissociation of the contaminant molecule.

Suitable solid-state species conductors will no doubt occur to the skilled addressee, examples of which may include but are not strictly limited to; for H⁺, CaZr_{0.9}In_{0.1}O₃₋ₓ, BaZr_{0.9}Y_{0.1}O₃₋ₓ, Ba₃Ca_{1.18}Nb_{1.82}O₉₋ₓ, SrCe_{0.95}Yb_{0.05}O_{2.975} and for Ag⁺, silver salts (for example, but not limited to, silver chloride). Other examples include, but are not strictly limited to; for H⁺, organic membranes, inorganic membranes, polymer membranes and other commercially available species conductors (for example, but not limited to Nafion™ or Nasicon™); O²⁻, yttrium stabilised zirconia (YSZ) and silver salts (for example, but not limited to, silver chloride).

To meet the requirements for monitoring contaminant species within the semiconductor processing environment it is necessary to identify a suitable sensing technology that is independent of the total pressure and that will provide a log-linear output signal in order to measure across a wide pressure range. In addition it is also necessary that the sensing material will not become depleted or otherwise affected by constant exposure to the reducing environment within the vacuum. The inventors have found that with suitable adaptation, solid-state electrochemical materials can meet these requirements.

The selection of the electrochemical solid-state electrolyte for such a sensor will depend upon the target contaminant gas of interest and in particular upon its dissociated ionic species. The electrolyte is selected to have properties that will enable it to conduct an ionic species of the target gas. Conduction of the ionic species will generate an electronic signal that can be measured to provide an indication of the quantity of contaminant gas within the monitored environment. In addition, to improve the selectivity of such a device it is extremely important to select a catalytic electrode material that will maximise the dissociation of the target contaminant gas to its ionic species (whilst minimising the dissociation of other species that are not of interest). To provide a calibrated output signal it is also necessary to provide a reference device that is matched to the concentration range of the contaminant gas to be measured thereby minimising any effect of the electrochemical semi-permeability of the electrolyte material. The reference device (of known concentration) is provided at a reference electrode and the concentration gradient across the electrochemical sensor (i.e. between the measurement and the reference electrode) is used to calculate the contaminant gas concentration at the measurement electrode.

Whilst the selection of materials for the construction of such a sensor is important it is also necessary to engineer the construction of the sensor in a manner that is compatible with installation into a vacuum environment. Considering the sensor will be placed within a vacuum environment that may have a pressure approximately 1 billion times less than atmospheric pressure (i.e. at 1 e⁻⁶ mbar) the proper design and construction of an effective vacuum seal for the sensor is essential. The vacuum seal is an extremely important part of any device intended for insertion into a vacuum environment and provides a leak-tight seal between the vacuum environment and the surrounding ambient environment. Manufacturing an effective seal is not a trivial matter and requires specific skills in order to seal metallic to ceramic materials and to allow for the feed-through of the necessary electrical connections whilst maintaining a leak-tight structure.

Finally, the mechanical design and construction of a sensor intended for use in vacuum environments is also important. The number of molecules within a vacuum environment is significantly lower than at atmosphere (i.e. approx. 1 billion times less at 1 e⁻⁶ mbar). In addition, the flow characteristics of residual gases in a vacuum environment are governed by probabilistic molecular flow mechanics. Hence, it is necessary to construct a vacuum sensor in such a manner that the sensing component design, construction and positioning is such to maximise interaction with the gaseous species of interest in the residual atmosphere.

In a second aspect, the present invention provides a method of detecting or monitoring the presence of a contaminant molecule in a monitored environment, the method comprising the steps of providing an electrochemical cell comprising a measurement electrode comprising a catalyst selected for its ability to catalyse the dissociation of a contaminant molecule into its ionic species, a reference electrode comprising a catalyst selected for its ability to catalyse the dissociation of a reference molecule into its ionic species, and a solid-state ionic species conductor bridging the measurement electrode and the reference electrode, the conductor being selected to conduct an ionic species common to the dissociated contaminant and reference molecules, providing, on a side of the cell bounded by the reference electrode, a source of the reference molecules, initiating the catalysis of the dissociation of the reference and contaminant molecules, monitoring a parameter of an electrical current produced in the cell, and from the monitored parameter, calculating the partial pressure of the contaminant molecule in an environment on the side of the cell bounded by the measurement electrode relative to that on the side of the cell bounded by the reference electrode.

For the purposes of exemplification, some embodiments of the invention will now be further described with reference to the figures in which;

FIG. 1 shows an electrochemical sensor configured for use in normal ambient pressures as known from the prior art;

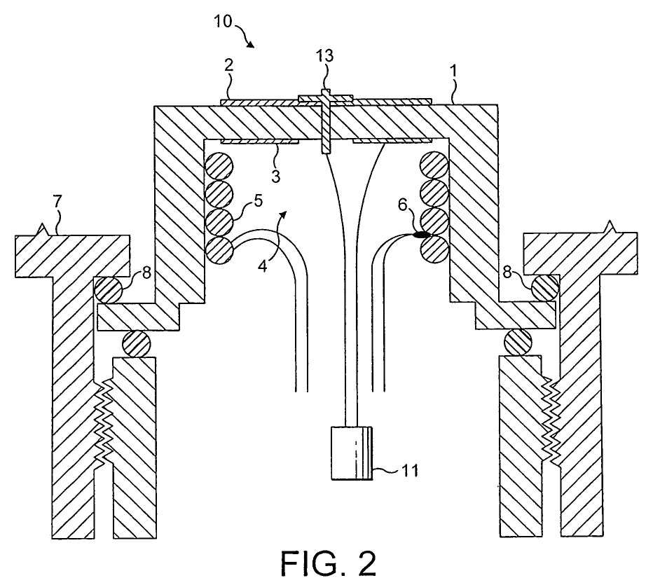

FIG. 2 shows a contaminant molecule sensor in accordance with a first embodiment of the invention;

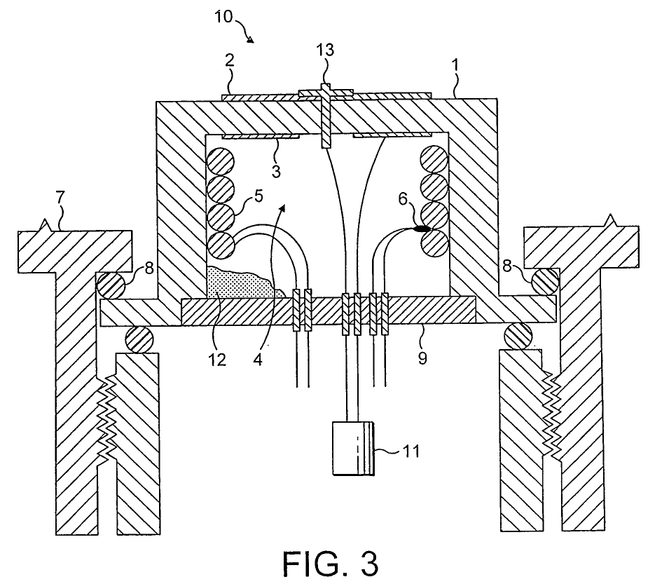

FIG. 3 shows a contaminant molecule sensor in accordance with a second embodiment of the invention;

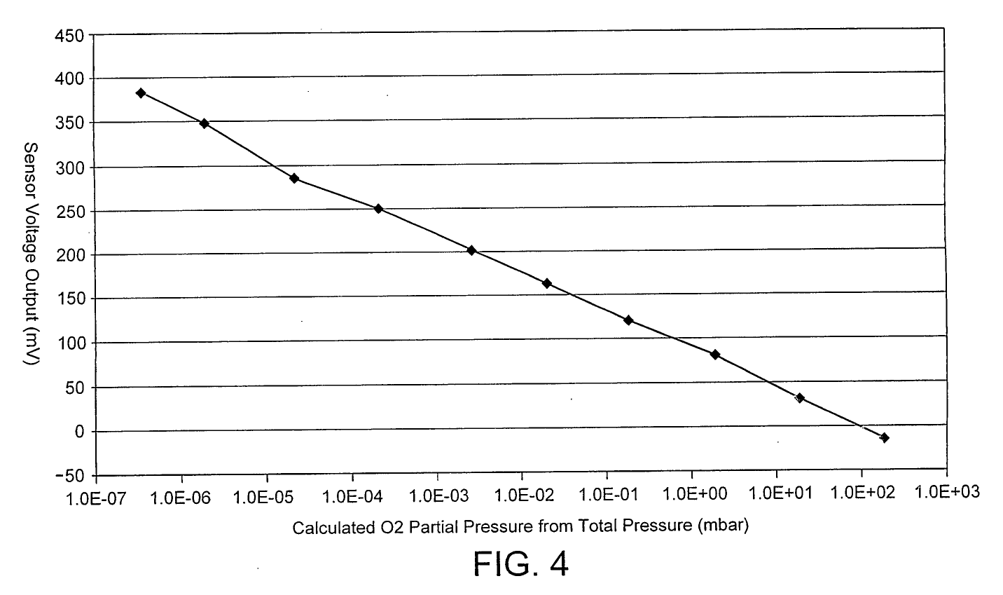

FIG. 4 shows a plot of emf versus partial pressure of a contaminant molecule for one embodiment of the invention.

As shown in FIG. 1, the prior art sensor comprises a reference electrode 103 and a measurement electrode 102. A species conductor 101 bridges the gap between the electrodes. The measurement electrode 102 encloses a monitored environment 110. Gas to be monitored is introduced into the monitored environment 110 through pipe 121 via pipe inlet 121a. The gas exits the monitored environment 110 through pipe 122 via pipe outlet 122a. Encircling the cell is a coil heating wire 105.

The sensor of the current invention is constructed specifically for insertion into vacuum systems. FIGS. 2 and 3 show two particular embodiments of the invention with internal and external heater arrangements. The sensor head is designed to maximise exposure of the measurement electrode to the vacuum environment. To provide heating to the sensor head a heater arrangement may be used that is either internal to the sensor body, as shown in the particular embodiment of FIG. 2, or external to the sensor body and encapsulated in an insulation material, for example but not limited to a vacuum compatible glass material, as shown in the particular embodiment of FIG. 3. In both cases the heater is located to minimise the radiation of heat from the sensor to the surrounding vacuum environment where it would lead to outgassing issues.

As can be seen in FIG. 2 an embodiment of the invention comprises a species conductor 1 bridging the gap between a reference electrode 3 and a measurement electrode 2. The species conductor 1 is heated by a nichrome wire heater 5 enclosed within the reference environment space 4. The temperature of the heater 5 is monitored and controlled by a thermocouple device 6. A vacuum feed-through seal 8 is provided around the cell at a distance from the end which carries the conductor 1. This allows the device to be mounted within a monitored environment 10, for example, a vacuum chamber via a vacuum flange 7 whilst enabling exposure of the inner reference environment space 4 to a separate environment which may have different properties to the monitored environment.

FIG. 3 shows an alternative embodiment of the invention. As in FIG. 2, the sensor comprises a species conductor 1 bridging the gap between a reference electrode 3 and a measurement electrode 2. The species conductor 1 is heated by a nichrome wire heater 5 which is contained within the reference environment space. The temperature of the heater 5 is monitored and controlled by a thermocouple device 6. A vacuum feed-through seal 8 is provided around the cell at a distance from the end which carries the conductor 1. This allows the device to be mounted within a monitored environment 10, for example, a vacuum chamber via a vacuum flange 7. In this embodiment, a seal 9 encloses a reference environment space 4. Electrical connectors are passed through the seal for supplying the thermocouple and electrodes contained within the reference environment space 4. Typically, in this embodiment the reference environment comprises a solid-state source of the species 12.

FIG. 2 and FIG. 3 show schematically how these embodiments of the invention may be configured for operation in a potentiometric configuration. As can be seen, the emf difference between a reference electrode 3 and a measurement electrode 2 is measured by means of an emf measuring device 11 which is electrically connected to the two electrodes. The electrodes are separated by a species conductor 1 and connection to the measurement electrode is made via a vacuum feed-through connector 13.

In one example of a specific potentiometric configuration of the type shown in FIG. 2 and FIG. 3, the molecule monitored is water vapour H₂O, the ionic species conducted is H⁺, and the reference molecule is H₂ gas. In this configuration, platinum provides a suitable material for the catalyst of both the measurement electrode and the reference electrode, as the reaction kinetics at the platinum measurement electrode 2 and the platinum reference electrode 3 produce a common ionic species as follows respectively:
H₂O_{(g)} [symbol] 2H⁺+½O_{2(g)}+2e⁻
H_{2(g)} [symbol] 2H⁺+2e⁻

In such an arrangement, it can be shown that the emf across the cell will have a dependence described by the following equation:

$$E ∝ \frac{RT}{F} ln ( \frac{{P}_{{H}_{2 ( REF )}}}{{a}_{{H}^{+}}} )$$

where
E=electromotive force (emf)
R=gas constant
T=temperature in Kelvin
F=Farraday constant
P_{H2 (REF)}=partial pressure of reference source hydrogen
a=H⁺ activity at the measurement electrode

From a, the partial pressure of moisture in the monitored environment can be empirically calculated.

This equation can be incorporated into microprocessors along with algorithms for determining the partial pressure of the monitored contaminant molecule. A display may be associated with the microprocessor from which the calculated partial pressure of the contaminant molecule can be directly read. Such a system may further incorporate an alarm configured to alert a user when a predefined partial pressure of the monitored contaminant material is exceeded.

FIG. 4 shows the relationship between partial pressure and emf measured in the electrochemical cell of a sensor according to the invention.

In summary, a contaminant molecule sensor comprises an electrochemical cell. The cell comprises a measurement electrode 2, a reference electrode 3 and a solid-state ionic species conductor 1 bridging the measurement electrode and the reference electrode. The measurement electrode comprises a catalyst selected for its ability to catalyse the dissociation of a contaminant molecule into its ionic species. The reference electrode comprises a catalyst selected for its ability to catalyse the dissociation of a reference molecule into its ionic species. The conductor is selected to conduct an ionic species common to the dissociated contaminant and reference molecules.

1. A contaminant molecule sensor configured for use in a vacuum environment, the sensor comprising:
an electrochemical cell comprising
a measurement electrode comprising a catalyst selected for its ability to catalyze the dissociation of a contaminant molecule into its ionic species;
a reference electrode comprising a catalyst selected for its ability to catalyze the dissociation of a reference molecule into its ionic species; and
a solid-state ionic species conductor bridging the measurement electrode and the reference electrode, the conductor being selected to conduct an ionic species common to the dissociated contaminant and reference molecules; and
means for initiating catalysis of the dissociation of the reference and contaminant molecules.

2. The sensor according to claim 1, wherein the means for initiating the catalysis of the dissociation of the reference and contaminant molecules comprises means for controlling and monitoring the temperature of the cell.

3. The sensor according to claim 2, comprising means for separating a reference environment space from a monitored environment space, the means for controlling and monitoring the temperature of the cell including a heating device contained within the reference environment space.

4. The sensor according to claim 2, wherein the means for controlling and monitoring the temperature includes an electrically powered heater.

5. The sensor according to claim 4, wherein the electrically powered heater comprises nichrome wire.

6. The sensor according to any of claims 2, wherein the means for controlling and monitoring the temperature includes a temperature sensor.

7. The sensor according to claim 6, wherein the temperature sensor is a thermocouple.

8. The sensor according to claim 1, comprising a vacuum feed-through connection for providing an electrical connection to the measurement electrode.

9. The sensor according to claim 1, comprising seals for connection to a vacuum environment.

10. The sensor according to claim 1, wherein a reference environment space is at least partly bounded by the reference electrode and is open to the ambient atmosphere.

11. The sensor according to claims 1, wherein a reference environment space is at least partly bounded by the reference electrode and is enclosed by a seal.

12. The sensor according to claim 11, wherein electrical cables for connecting the electrodes and optionally an electric heating means with an electrical circuit external to the reference environment space pass through the seal.

13. The sensor according to claim 11, comprising, in the reference environment space, a solid-state source of the reference molecules.

14. The sensor according to claim 13, wherein the ionic species to be conducted is H⁺ and the solid-state source is selected from a metal, a metal/hydride, a metal alloy/metal-hydride, any hydrated species, and any organic species.

15. The sensor according to claim 13, wherein the ionic species to be conducted is O²⁻ and the solid-state source is selected from a metal, a metal alloy and a metal oxide.

16. The sensor according to claim 15, wherein the metal is copper (Cu) and the oxide is Cu₂O.

17. The sensor according to claim 15, wherein the metal is chromium (Cr) and the oxide is Cr₂O₃.

18. The sensor according to claim 15, wherein the metal is nickel (Ni) and the oxide is NiO.

19. The sensor according to claim 13, wherein the ionic species to be conducted is Ag⁺ and the solid-state source is a silver salt.

20. The sensor according to claim 19, wherein the solid state source is silver chloride.

21. The sensor according to claim 11, comprising, in the reference environment space, a liquid state source of the ionic species.

22. The sensor according to claim 21, wherein the ionic species to be conducted is H⁺ and the source comprises a liquid acid.

23. The sensor according to claim 21, wherein the ionic species to be conducted is H⁺ and the source comprises an organic liquid.

24. The sensor according to claim 11, comprising, in the reference environment space, a gaseous state source of the ionic species.

25. The sensor according to claim 1, wherein the solid-state ionic species conductor conducts H⁺.

26. The sensor according to claim 25, wherein the solid-state species conductor is selected from CaZr_{0.9}In_{0.1}O₃₋ₓ, BaZr_{0.9}Y_{0.1}O₃₋ₓ, Ba₃Ca_{1.18}Nb_{1.82}O₉₋ₓ, SrCe_{0.95}Yb_{0.05}O_{2.975} organic membranes, inorganic membranes, polymer membranes, Nafion™ and Nasicon™.

27. The sensor according to claims 1, wherein the solid-state ionic species conductor conducts O²⁻ ions.

28. The sensor according to claim 27, wherein the solid-state species conductor comprises Yttria Stabilized Zirconia (YSZ).

29. The sensor according to claim 1, wherein the solid-state ionic species conductor conducts Ag⁺.

30. The sensor according to claim 29, wherein the solid-state ionic species conductor comprises a silver salt.

31. The sensor according to claim 30, wherein the solid-state ionic species conductor is silver chloride.

32. The sensor according to claim 1, wherein the catalyst for the measurement electrode is the same as the catalyst for the reference electrode.

33. The sensor according to claim 1, wherein at least one of the catalysts comprises platinum.

34. The sensor according to claim 1, wherein at least one of the catalysts comprises ruthenium.

35. The sensor according to claim 1, wherein at least one of the catalysts comprises gold.

36. The sensor according to claim 1, wherein at least one of the catalysts comprises a catalyzing oxide.

37. The sensor according to claim 1, wherein at least one of the catalysts comprises a silver salt.

38. The sensor according to claim 1, comprising means for monitoring a parameter of an electrical current produced in the cell, and means for calculating from the monitored parameter the partial pressure of the contaminant molecule in an environment on a side of the cell bounded by the measurement electrode relative to that on a side of the cell bounded by the reference electrode.

39. The sensor according to claim 38, wherein the monitoring means comprises an emf measuring device electrically connected to the reference and measuring electrodes.

40. A method of detecting or monitoring the presence of a contaminant molecule in a monitored environment, the method comprising the steps of:
providing an electrochemical cell comprising
a measurement electrode comprising a catalyst selected for its ability to catalyze the dissociation of a contaminant molecule into its ionic species;
a reference electrode comprising a catalyst selected for its ability to catalyse catalyze the dissociation of a reference molecule into its ionic species; and
a solid-state ionic species conductor bridging the measurement electrode and the reference electrode, the conductor being selected to conduct an ionic species common to the dissociated contaminant and reference molecules;
providing, on a side of the cell bounded by the reference electrode, a source of the reference molecules;
initiating the catalysis of the reference and contaminant molecules;
monitoring a parameter of an electrical current produced in the cell; and
calculating, from the monitored parameter, the partial pressure of the contaminant molecule in an environment on the side of the cell bounded by the measurement electrode relative to that on the side of the cell bounded by the reference electrode.

41. The method according to claim 40, wherein the monitored parameter is electromotive force.

42. The method according to claim 40, wherein catalysis of the contaminant molecule is initiated by heating the cell.

43. The method according to claim 40, wherein the reference molecule is the same as the contaminant molecule.

44. The method according to claim 40, wherein the catalyst for the measurement electrode is the same as the catalyst for the reference electrode.

45. (canceled)
